(19) United States
(12) Patent Application Publication
(10) Pub. No.: US 2024/0310050 A1
(43) Pub. Date: Sep. 19, 2024

(54) DOMESTIC APPLIANCE WITH STAND-BY FUNCTION

(71) Applicant: ELECTROLUX APPLIANCES AKTIEBOLAG, Stockholm (SE)

(72) Inventors: Alex VIROLI, Forli (IT); Massimo NOSTRO, Forli (IT); Filippo MILANESI, Forli (IT); Jose PEREZ, Rothenburg ob der Tauber (DE)

(21) Appl. No.: 18/272,928

(22) PCT Filed: Jan. 13, 2022
(86) PCT No.: PCT/EP2022/050667

§ 371 Date: Jul. 18, 2023

(30) Foreign Application Priority Data
Jan. 20, 2021 (EP) 21152451.7

(51) Int. Cl. F24C 7/08; H05B 1/02; H05B 6/06

(52) U.S. Cl. CPC F24C 7/083; H05B 1/0266; H05B 6/062

(57) ABSTRACT

There is described a domestic appliance (1), in particular a cooking hob (2), for the thermal treatment of food products comprising at least one or more cooking zones (2), a power supply unit (5) being controllable into at least a stand-by mode and a powered-on mode and being configured to supply an energy to the one or more cooking zones (2) when being controlled in the pow-cred-on mode and a control group (17) coupled to the power supply unit (5) and configured to control the power supply unit (5) from the stand-by-mode into the powered-on mode; wherein the control group (17) is controllable between a rest configuration and an active configuration at which control group (17) is configured to set the power supply unit (5) from the stand-by-mode into the powered-on mode. The control group (17) comprises at least one magnetic switching device (18) having a magnetic and/or ferromagnetic element (19), the magnetic and/or ferromagnetic element (19) being moveable between at least a rest state and an active state. The control group (17) is controlled in the rest configuration and the active configuration with the magnetic and/or ferromagnetic element (19) being positioned in respectively the rest state and the active state. The magnetic and/or ferromagnetic element is biased in the rest state and is controllable by means of interaction with a metallic and/or magnetic and/or ferromagnetic activation device into the active state.

The present invention relates to a domestic appliance, in particular a cooking hob, for the thermal treatment of food products and being provided with a stand-by function.

Advantageously, the present invention relates to a domestic appliance, in particular a cooking hob, for the thermal treatment of food products and being provided with a stand-by function, which comes along with a minimized power consumption.

Domestic appliances, such as cooking hobs or ovens, for the thermal treatment of food products are known.

A typical domestic appliance comprises one or more cooking zones for the thermal treatment of the food product. E.g. in the case of cooking hobs, each one of the cooking zones is configured to support, in use, one respective cooking vessel containing the food product, and being selectively controllable so as to heat e.g. by means of induction heating, the respective cooking vessel and, accordingly, also the food product being placed within the respective cooking vessel.

Furthermore, a typical domestic appliance comprises a power supply unit, which is connectable to an external power supply, and which is configured to supply energy to the cooking zones.

Additionally, a typical domestic appliance may be provided with a stand-by unit which is configured to set the power supply unit and therewith the domestic appliance itself into a stand-by mode when the domestic appliance is not in use.

An inconvenience seen with respect to the known stand-by units is that their function requires the supply of energy.

A need is felt in the sector to improve the known domestic appliances being provided with stand-by function for at least reducing the needed energy when being in stand-by, in particular to substantially avoid any energy consumption.

One aim of the present invention is to provide for a domestic appliance for the thermal treatment of food products, to overcome, in a straightforward manner, at least one of the aforementioned inconveniences.

In particular, one aim of the present invention is to provide for a domestic appliance for the thermal treatment of food products being provided with a stand-by function, which comes along with a reduced power consumption.

According to the present invention, there is provided a domestic appliance according to the independent claim.

Preferred non-limiting embodiments are claimed in the claims directly or indirectly depending on the independent claim.

In addition, according to the present invention, there is provided a domestic appliance, in particular a cooking hob, for the thermal treatment of food products comprising at least:
one or more cooking zones;
a power supply unit being controllable into at least a stand-by mode and a powered-on mode and being configured to supply energy to the one or more cooking zones when being controlled in the powered-on mode; and
a control group coupled to the power supply unit and configured to control the power supply unit from the stand-by-mode into the powered-on mode. The control group is controllable between a rest configuration and an active configuration at which control group is configured to set the power supply unit from the stand-by-mode into the powered-on mode.

The control group comprises at least one magnetic switching device having a magnetic and/or ferromagnetic element, the magnetic and/or ferromagnetic element being moveable between at least a rest state and an active state.

The control group is controlled in the rest configuration and the active configuration with the magnetic and/or ferromagnetic element being positioned in respectively the rest state and the active state.

The magnetic and/or ferromagnetic element is biased in the rest state and is controllable by means of interaction with a metallic and/or magnetic and/or ferromagnetic activation device into the active state.

By providing for the magnetic and/or ferromagnetic element, which needs to be moved from the rest state to the active state by a magnetic interaction with the activation device, it is possible to power-on the power supply unit (and the domestic appliance, in particular the cooking hob) and to guarantee a minimal power consumption, actually being substantially zero, when the power supply unit is in the stand-by mode.

In particular, with the power supply unit being controlled in the stand-by mode, any supply of energy to the cooking zones is impeded, while with the power supply unit being controlled in the powered-on mode, supply of energy to the cooking zones is enabled.

In particular, by approaching, in use, the activation device towards the magnetic and/or ferromagnetic element (and the magnetic switching device) it is possible to control the magnetic and/or ferromagnetic element from the rest state to the active state, while removal of the activation device results in a returning of the magnetic and/or ferromagnetic element into the rest state (due to the biasing of the magnetic and/or ferromagnetic element in the rest state). In other words, in the case that no forces act on the magnetic and/or ferromagnetic element it is automatically controlled in the rest state and only upon the acting of a magnetic force (due to the approaching and/or approached) activation device it is possible to control the magnetic and/or ferromagnetic element into the active state.

According to some possible non-limiting embodiments, by setting the power supply unit into the stand-by mode or in the powered-on mode one also sets the domestic appliance, in particular the cooking hob, into respectively the stand-by mode and the powered-on mode.

According to some possible non-limiting embodiments, the food product to be thermally treated may be a single ingredient or a mixture of ingredients. It should also be noted that the food product to be treated may vary throughout the overall thermal treatment process; i.e. it may be possible to add or remove ingredients to the food product during the thermal treatment.

According to some possible non-limiting embodiments, the activation device is provided in the form of a cooking vessel, in particular the cooking vessel having magnetic and/or ferromagnetic properties.

Alternatively or in addition, the domestic appliance, in particular the cooking hob, could comprise a distinct activation device, e.g. in the form of a magnetic and/or ferromagnetic bar, disc, pen or similar. It should be stressed that distinct means that the activation device is different and distinct from a cooking vessel.

This allows to interact with the magnetic and/or ferromagnetic element also in the case that the cooking vessel is e.g. realized from aluminum, copper or non-magnetic steel or any other non-magnetic and/or non-ferromagnetic material.

Furthermore, another advantage associated to the distinct activation device that one may use the distinct activation device for marketing purposes by e.g. placing a brand logo onto the distinct activation device.

In particular, the distinct activation device, in particular the magnetic and/or ferromagnetic bar, disc, pen or the like, may comprise at least a portion having magnetic and/or ferromagnetic properties.

Preferentially but not necessarily, the domestic appliance, in particular the cooking hob, could comprise a seat, such as a housing cavity, a housing channel, a housing recess or the like, for receiving and housing the distinct activation device when not in use.

In this way, one ensures that the distinct activation device is placed at a specific location of the domestic appliance and can be easily found by a user.

Possibly, the seat may comprise locking and unlocking means so as to respectively lock and unlock the distinct activation device into and from the seat. Thereby, one ensures on the one side that the distinct activation device is not unwantedly lost and on the other side to allow its removal from the seat.

Alternatively or in addition, the seat may comprise a housing space and a moveable cover for selectively closing and opening the housing space. This is a further solution allowing to safely storing the distinct activation device.

According to some further non-limiting embodiments, the seat and the distinct activation device may be complementary to one another. This permits to safely store the distinct activation device.

According to some possible non-limiting embodiments, the seat and the distinct activation device may be designed such that the distinct activation device is flush with a surface of the domestic appliance, in particular the cooking hob, when being placed within the seat. Thereby, one can improve the aesthetical appearance of the domestic appliance.

According to some possible non-limiting embodiments, a cooking vessel can be of any type and form. A non-exhaustive list of cooking vessels are pans, pots and kettles.

According to some possible non-limiting embodiments, the power supply unit is configured to supply energy in the form of electrical energy. Alternatively, the power supply unit could be configured to supply energy in the form of a gas to be burned.

According to some preferred non-limiting embodiments, the domestic appliance, in particular the cooking hob, further comprises an auxiliary control device configured to enter an activated configuration with the control group being set from the rest in configuration the active configuration. The auxiliary control device is configured to retain, in particular when being in the activated configuration, the power supply unit in the powered-on mode with the control group being set back from the rest configuration in the active configuration.

In this way, it is guaranteed that the power supply unit is maintained in the powered-on mode even if the actuation device is distanced from the magnetic switching device and the magnetic and/or ferromagnetic element and once the control device has powered on the power supply unit. E.g. in this manner one avoids the need to leave the actuation device arranged in the proximity of the magnetic element for maintaining the control group in the active configuration. In particular, once the power supply unit is in the powered-on mode, it is the auxiliary control device, which guarantees that power supply unit remains in the powered-on mode.

Preferentially but not necessarily, the auxiliary control device is configured to retain the power supply unit in the powered-on mode for a determined time after setting, in use, the control group from the active configuration into the rest configuration and/or after interrupting, in use, the supply of the energy to the one or more cooking zones.

In this way, it is guaranteed that the power supply unit (and therewith the domestic appliance) will remain in the powered-on mode for a determined time even if the control group is returned back in the rest configuration (and after having been in the active configuration) and/or no supply of energy to the cooking zones occurs. E.g. this allows a user to power on the power supply unit and to activate the actual thermal treatment later and/or to shortly interrupt a first thermal treatment process and to initiate another one shortly after without the need to newly rely on the activation device.

Even more preferentially but not necessarily, the auxiliary control device is configured to control the power supply unit into the stand-by mode after a first time since the setting of the control group from the active configuration into the rest configuration supersedes a first determined time and/or after a second time since interruption, in use, of the supply of the energy to the one or more cooking zones supersedes a second determined time.

In this manner, it is possible to control the actual time the power supply unit should be kept in the powered-on mode before the power supply unit is controlled back into the stand-by mode. The first determined time and the second determined time may equal one another or may be different.

According to some preferred non-limiting embodiments, the auxiliary control device is set in a deactivated configuration with the power supply unit being controlled in the stand-by-mode, in particular when being in the deactivated configuration the auxiliary control device is impeded from executing any control operating on the power supply unit. E.g. the auxiliary control device cannot control the power supply unit from the stand-by mode to the powered-on mode.

This guarantees that once power supply unit is set back in the stand-by mode only the control group can set the power supply unit back in the powered-on mode. This also guarantees that substantially no power is consumed when the power supply unit is in the stand-by mode.

According to some preferred non-limiting embodiments, the auxiliary control device comprises an auxiliary electric circuit and an auxiliary switching device for selectively setting the auxiliary electric circuit into a respective opening state and a respective closing state. The auxiliary electric circuit is set in the opening state with the power supply unit being set in the stand-by mode, and in particular is set by the control group into the closing state when the control group itself is controlled from the rest configuration to the active configuration. In particular, the auxiliary control device is in the activated configuration and the deactivated configuration with the auxiliary electric circuit being controlled in respectively the closing state and the opening state.

In this manner, one guarantees that the auxiliary control device is set back into the deactivated configuration so that only the control group can set the power supply unit into the powered-on mode.

Preferentially but not necessarily, the auxiliary switching device is configured to retain the auxiliary electric circuit in the closed state after the control group is controlled, in use, back from the active configuration to the rest configuration.

In this manner, one guarantees that the power supply unit is kept in the powered-on mode, even though the control group is controlled back into the rest configuration.

According to some possible non-limiting embodiments, the auxiliary switching device comprises a relay and a switching element controlled by the relay. In particular, the relay is configured to control the switching element such to selectively set the auxiliary switching device in the deactivated configuration and an operative configuration at which the auxiliary switching device is configured to retain the power supply unit in the powered-on mode.

According to some preferred non-limiting embodiments, the control group comprises an electric control circuit having the magnetic switching device and being configured to be set between an open state and a closed state. The electric control circuit is in the open state and the closed state with the magnetic and/or ferromagnetic element being in respectively the rest state and the active state.

By providing for the electric control circuit one obtains a simple solution on how to control the power supply unit from the stand-by mode to the powered-on mode.

According to some preferred non-limiting embodiments, the magnetic switching device comprises a reed switch carrying and/or defining and/or comprising the magnetic and/or ferromagnetic element.

The reed switch defines an easy solution for a magnetic switching device.

According to some preferred non-limiting embodiments, the magnetic switching device comprises a moveable elongated switching element carrying the magnetic and/or ferromagnetic element at a first end portion.

Preferentially but not necessarily, the switching element is axial moveable around a rotation axis for moving the magnetic and/or ferromagnetic element between at least a first angular position and a second angular position at which the magnetic and/or ferromagnetic element is in respectively the rest state and the active state.

Even more preferentially but not necessarily, the switching element may also comprise a contact portion being configured to set the electric control circuit in the open state and the closed state with the magnetic and/or ferromagnetic element being controlled into respectively the first angular position and the second angular position.

According to some possible non-limiting embodiments, the domestic appliance, in particular the cooking hob, further comprises a (dielectric) support panel comprising and/or at least partially carrying the one or more cooking zones. The support panel comprises a first face and a second face opposed to the first face. Each cooking zone is configured to support at least one respective cooking vessel facing and/or contacting thereby the first face of the support panel. The magnetic switching device is arranged adjacent to and faces the second face.

In this way, one guarantees that the magnetic switching device can interact with the actuation device.

According to some possible non-limiting embodiments, each one of the cooking zones may be configured to be intended as any portion of the domestic appliance, in particular the cooking hob, which is configured to support the cooking vessel and which is provided with means for directing thermal energy in any form into and/or to the cooking vessel and/or into the product being present within the cooking vessel. E.g. the cooking zone can be defined by a support portion of the support panel for the support of the cooking vessel and an electronic element such as an electrical resistance or an induction coil, being associated to (e.g. being arranged below of) the support portion. Another example is a cooking zone being defined by support elements for supporting the cooking vessel and a nozzle arranged below at least portions of the support elements and configured to allow for a controlled outflow and burning of a burning gas.

According to some possible non-limiting embodiments, the domestic appliance, in particular the cooking hob, further comprises a main control unit configured to control the supply of the energy to the one or more cooking zones. In particular, the main control unit is coupled to the power supply unit and the cooking zones.

According to some possible non-limiting embodiments, each one of the one or more cooking zones comprises a respective induction coil. In particular, each cooking zone further comprises one or more generators, each one coupled to at least one respective induction coil for driving the respective induction coil.

According to some possible non-limiting embodiments, the power supply unit is connectable to an external power supply. The control group, in particular the electric control circuit, is designed to apply an energy from the external power supply to the power supply unit when being, in use, controlled in the respective active configuration.

An example external power supply is the common power supply of the household within which the domestic appliance is installed.

In this manner, one connects the external power supply to the external power supply.

According to some non-limiting embodiments, the domestic appliance, in particular the cooking hob, comprises a plurality of magnetic switching devices, at least some of which are associated to one respective cooking zone. Each one of the magnetic switching devices is configured to set the control device into the respective active configuration.

Thereby, one obtains the possibility to approach the activating device, e.g. the cooking vessel, directly to the cooking zone thereby automatically powering on the power supply unit.

Three non-limiting embodiments of the present invention will now be described, by way of example, with reference to the accompanying drawings, in which:

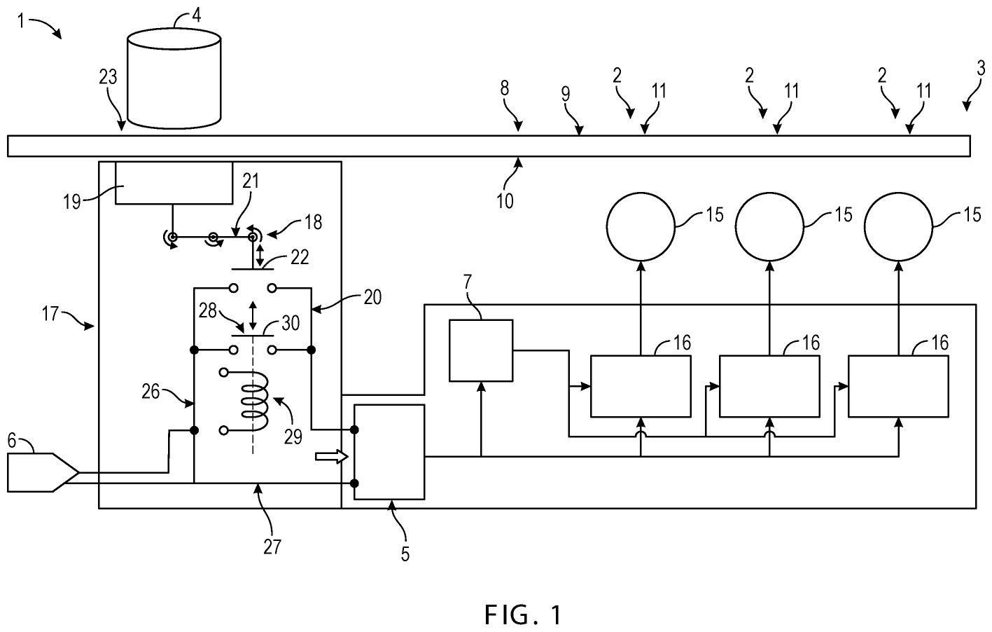

FIG. 1 is a schematic sketch of a first embodiment of a domestic appliance according to the present invention, with parts removed for clarity;

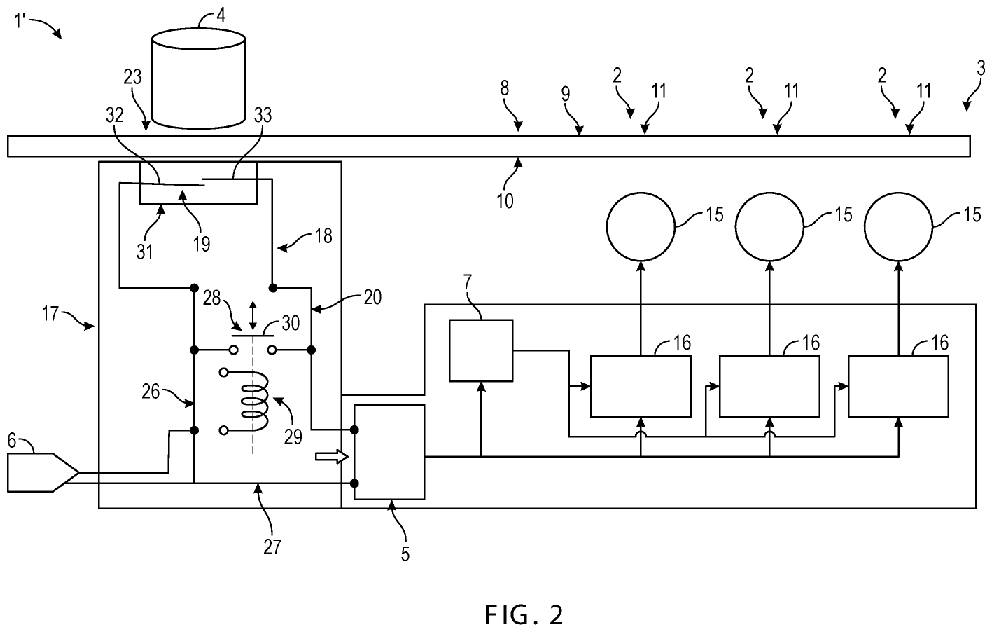

FIG. 2 is a schematic sketch of a second embodiment of a domestic appliance according to the present invention, with parts removed for clarity; and

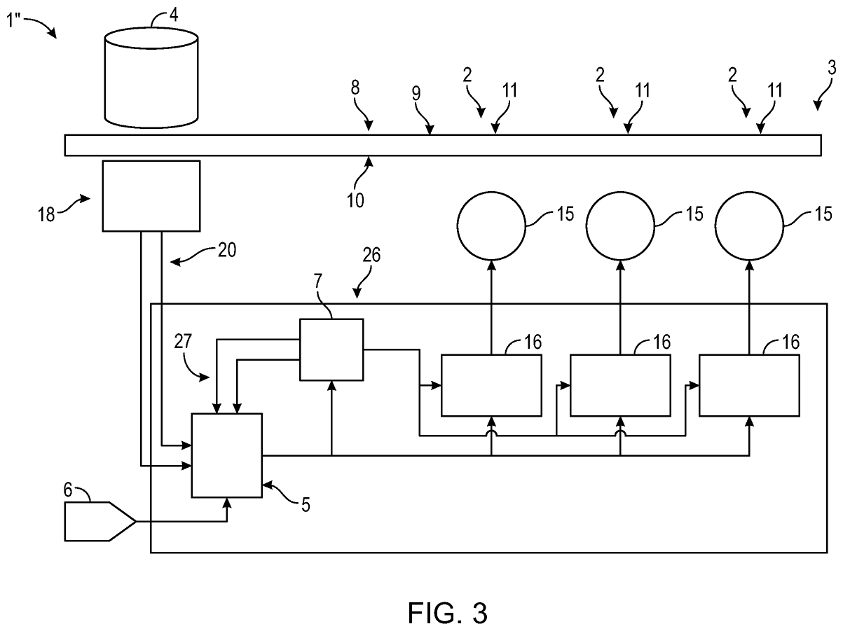

FIG. 3 is a schematic sketch of a third embodiment of a domestic appliance according to the present invention, with parts removed for clarity.

With particular reference to FIG. 1, number 1 indicates as a whole a domestic appliance for the thermal treatment, in particular for the heating and/or cooking, of a food product.

Domestic appliance 1 comprises one or more cooking zones 2, in particular each one being configured to selectively and independently from the others heat a respective food product.

In the specific embodiment disclosed, domestic appliance 1 comprises a cooking hob 3 having (at least some) cooking zones 2, each cooking zone 2 being configured to support a respective cooking vessel 4, such as a pan, a pot, a kettle and the like, and to heat the respective cooking vessel 4 and the food product present within the respective cooking vessel 4.

Alternatively or in addition, domestic appliance 1 could comprise an oven having one respective cooking zone being defined by the inner space of the oven.

According to some possible embodiments, cooking vessel (s) 4 comprise (in particular substantially consist of) a magnetic and/or ferromagnetic material. Example cooking vessels 4 are e.g. the ones being adapted to be used with induction heating.

Alternatively, cooking vessels 4 could comprise (in particular substantially consist of) a non-magnetic material such as aluminum, copper or non-magnetic steel.

With particular reference to FIG. 1, domestic appliance 1, in particular cooking hob 2, comprises at least one power supply unit 5 controllable into at least a stand-by mode and a powered-on mode and being configured to supply an energy to cooking zones 2 when being controlled in the powered-on mode.

In particular, power supply unit 5 is electrically connectable to an external power supply 6, e.g. of the household within which domestic appliance 1 is installed.

According to the embodiment shown, power supply unit 5 is configured to supply an electrical energy to cooking zones 2. Accordingly, external power supply 6 allows to direct electrical energy to power supply unit 5.

Alternatively, power supply unit 5 could be configured to supply a flow of gas to cooking zones 2. According to such an alternative embodiment, external power supply 6 would deliver a flow of gas to power supply unit 5.

In particular, with power supply unit 5 being in the standby-mode and the powered-on mode also domestic appliance 1, in particular cooking hob 3, is respectively in stand-by and turned on.

Furthermore, domestic appliance 1, in particular cooking hob 3, comprises a main control unit 7 operatively (and electrically) connected to power supply unit 5 (and to cooking zones 2) and configured to selectively control the supply of the energy by power supply unit 5 to cooking zones 2.

Additionally, domestic appliance 1, in particular cooking hob 3, may comprise a control interface (not shown), such as e.g. a touch display and/or having one or more control knobs, configured to allow for the setting and/or definition of one or more respective operating parameters of cooking zones 2, in particular prior, during and/or after the thermal treatment of the food product.

In particular, the control interface may be operationally connected to main control unit 7 and main control unit 7 may be configured to control the supply of energy to cooking zones 2 in function of the respective operating parameters.

With particular reference to FIG. 1, domestic appliance 1, in particular cooking hob 3, may comprise a support panel 8 comprising and/or at least partially carrying (at least a portion of) cooking zones 2.

In more detail, support panel 8 comprises a first face 9 and a second face 10 opposed to first face 9.

Furthermore, each cooking zone 2 comprises at least a support portion 11 of support panel 8. In particular, the respective section of first face 9 is designed to support the respective cooking vessel 4 during the thermal treatment.

Preferentially, each cooking zone 2 of cooking hob 3 may comprise at least one respective induction coil 15, in particular arranged adjacent to the respective support portion 11 and facing second face 9.

Even more preferentially, each cooking zone 2 may also comprise at least one respective generator 16 operatively and electrically coupled to the respective coil 15 and to power supply unit 5 and configured to receive the supply of the energy and to drive the respective induction coil 15.

Furthermore, main control unit 7 may be operatively connected to generators 16 and being configured to selectively control operation of each generator 16 (for selectively controlling operation of each cooking zone 2).

Domestic appliance 1, in particular cooking hob 3, comprises a control group 17 coupled to power supply unit 5 and configured to control power supply unit 5 from the stand-by-mode into the powered-on mode. Control group 17 is biased in a rest configuration and is controllable from the rest configuration into an active configuration at which control group 17 sets power supply unit 5 from the stand-by-mode into the powered-on mode.

Control group 17 comprises at least one magnetic switching device 18 being provided with a magnetic and/or ferromagnetic element 19, which is moveable between at least a rest state and an active state. Furthermore, control group 17 is controlled in the rest configuration and the active configuration with magnetic and/or ferromagnetic element 19 being position in respectively the rest state and the active state.

Advantageously, magnetic and/or ferromagnetic element 19 is biased in the rest state and is controllable by means of (magnetic) interaction with a metallic and/or magnetic and/or ferromagnetic activation device into the active state.

More specifically, the magnetic and/or ferromagnetic element 19 is designed to move from the rest state to the active state as a result of the magnetic forces resulting from the interaction between magnetic and/or ferromagnetic element 19 and the activation device. In the absence of any acting magnetic force (due to the distanced activation device) magnetic and/or ferromagnetic element 19 is arranged in the rest state. Only the acting magnetic force allows to move magnetic and/or ferromagnetic element 19 into the active state and magnetic and/or ferromagnetic element 19 moves back into the rest state once the acting magnetic force vanishes due to a removal of the activation device.

Even more specifically, in use, the activation device is approached towards magnetic switching device 18 so as to move magnetic and/or ferromagnetic element 19 from the rest state to the active state, and in particular is removed from magnetic switching device 18 so as to control magnetic and/or ferromagnetic element 19 back into the rest state.

According to the non-limiting embodiment shown, the activation device may be formed by the cooking vessel 4 to be used (and to be placed on one of cooking zones 2).

Alternatively or in addition, domestic appliance 1, in particular cooking hob 3, may comprise a distinct activation device (being different from a cooking vessel 4), e.g. housed within a respective seat of domestic appliance 1, in particular cooking hob 3, which is designed to be used when controlling power supply unit 5 from the stand-by mode into the powered-on mode. E.g. according to such an embodiment, the activation device may be provided in the form of a bar, pen, disc or similar. Providing for such a distinct activation device allows to power on domestic appliance 1, in particular cooking hob 3, even more particular power supply unit 5, thereby not requiring to use a magnetic and/or ferromagnetic cooking vessel 4.

In particular, the distinct activation device, in particular the bar, disc, pen or the like, may comprise at least a portion having magnetic and/or ferromagnetic properties.

According to such a possible embodiment, the domestic appliance, in particular the cooking hob, may comprise the seat e.g. being formed by a housing cavity, a housing channel, a housing recess or the like, for receiving and housing the distinct activation device when not in use.

Possibly, the seat may comprise locking and unlocking means so as to respectively lock and distinct activation device into and from the seat.

Alternatively or in addition, the seat may comprise a housing space and a moveable cover for selectively closing and opening the housing space.

The seat and the distinct activation device may be complementary to one another.

According to some possible embodiments, the seat and the distinct activation device may be designed such that the distinct activation device is flush with a surface of the domestic appliance, in particular the cooking hob, when being placed within the seat.

In more detail, magnetic switching device 18 is (at least partially) arranged adjacent to support panel 8, e.g. a glass-ceramic panel, and in particular faces second face 10. In other words, magnetic switching device 18 and the activation device are separated by support panel 8 from one another.

In even more detail, magnetic and/or ferromagnetic element 19 is arranged adjacent to support panel 8 and in particular faces second face 10. Furthermore, magnetic and/or ferromagnetic element 19 may be designed to move towards second face 9 when being controlled from the rest state to the active state.

According to the embodiment shown, magnetic switching device 18 is arranged adjacent to an auxiliary portion 23 of support panel 8, which is distinct from support portions 11.

Alternatively or in addition, control group 17 could comprise a plurality of magnetic switching devices 18 at least some being associated to one respective cooking zone 2, in particular one respective induction coil 15. In other words, at least some magnetic switching devices 18 are arranged at the respective support portions 11 (adjacent to support panel 8 and each facing second face 9).

Additionally, control group 19 could also comprise an electric control circuit 20 electrically coupled to power supply unit 5 and having magnetic switching device 18 and being in an open state (impeding any flow of current through electric control circuit 20 itself) and a closed flow of current through electric control state (allowing circuit 20 itself) with magnetic and/or ferromagnetic element 19 being respectively in the rest state and the active state. In particular, electric control circuit 20 is designed to set, in use, power supply unit 5 from the standby-mode into the powered-on mode when being set from the open state in the closed state. Even more particular, electric control circuit 20 is electrically connected to the external power supply 6 and is designed to allow for an alternate current to flow from external power supply 6 to power supply unit 5 when being in the closed state and interrupt such a flow of the alternate current to the power supply unit 5 when being set in the open state.

In more detail, magnetic switching device 18 may comprise a moveable elongated switching element 21 carrying magnetic and/or ferromagnetic element 19 at a first end portion.

Furthermore, switching element 21 may be axial moveable around a rotation axis for moving magnetic and/or ferromagnetic element 21 between at least a first angular position and a second angular position at which magnetic and/or ferromagnetic element 21 is in respectively the rest state and the active state. Preferentially, switching element 21 may comprise a contact portion 22 being configured to set electric control circuit 20 in the open state and the closed state with magnetic and/or ferromagnetic element 19 being controlled into respectively the first angular position and the second angular position. Even more preferentially, contact portion 22 is connected to a second end portion of switching element 21 opposed to the first end portion.

More specifically, the rotation axis is disposed at a position being decentered with respect to the first end portion and the second end portion. In particular, the rotation axis is closer to the first end portion than to the second end portion.

Furthermore, in use, the magnetic force acting on magnetic and/or ferromagnetic element 19 due to the approached activation device actuates the rotation of switching element 21 so as to move magnetic and/or ferromagnetic element 19 from the first angular position to the second angular position.

According to the embodiment shown, magnetic element 19 is pivoted to the first end portion, and in particular contact portion 22 is pivoted to the second end portion.

Additionally, domestic appliance 1, in particular cooking hob 3, may further comprise an auxiliary control device 26 configured to enter (from a deactivated configuration) an activated configuration with control group 17 being set in the active configuration. Auxiliary control device 26 is configured to retain power supply unit 5 in the powered-on mode with control group 17 being set from the active configuration into the rest configuration. In particular, auxiliary control device 6 may be (electrically) connected to control group 17 and power supply unit 5.

Thus, by providing for auxiliary control device 26 power supply unit 5 remains in the powered-on mode even if the activation device is moved away from magnetic switching device 18. This means that power supply unit 5 can still supply energy to cooking zones 2 (even though magnetic and/or ferromagnetic element 19 is placed in the rest state), and in particular power supply unit 5 can still receive an alternate current from the external power supply 6.

If it was not for auxiliary control device 26 power supply unit 5 would not be able to supply any energy to cooking zones 2 after control group 17 has been controlled back from the active configuration to the rest configuration.

Furthermore, by providing for auxiliary control device 26 it is possible for main control unit 7 to continue to control cooking zones 2, in particular generators 16.

According to the specific embodiment shown, in order to control power supply unit 5 from the stand-by mode to the powered-on mode it is necessary for a user to approach the activation device, e.g. cooking vessel 4, towards magnetic switching device 18 and/or auxiliary portion 23 so as to move magnetic switching device 19 from the rest state to the active state. This allows setting electronic control circuit 20 into the closed state.

Furthermore, when removing the activation device, e.g. cooking vessel 4, away from magnetic switching device 18 and/or auxiliary portion 23, magnetic and/or ferromagnetic element 19 moves back to the rest state, in particular leaving electronic control circuit 20 in the open state. However, auxiliary control device 26 retains power supply unit 5 in the powered-on mode. Thus, even if auxiliary portion 23 is distinct from support portions 11 it is not necessary to keep the activation device approached to magnetic switching device 18, but once power supply unit 5 is set in the powered-on mode, it is possible to continue operating cooking zones 2.

In more detail, auxiliary control device 26 is configured to retain power supply unit 5 in the powered-on mode for a determined time after setting, in use, control group 17 from the active configuration into the rest configuration (by removing the activation device away from magnetic switching device 18) and/or after interrupting, in use, the supply of the energy to cooking zones 2.

In particular, main control unit 7 is configured to control the supply of the energy to cooking zones 2, in particular in dependence of the operating parameters. Once, the operating parameters are such to indicate (based on the input through the control interface) to stop the thermal treatment, main control unit 7 controls power supply unit 5 such to interrupt the supply of energy to cooking zones 2.

More specifically, auxiliary control device 26 may be configured to control power supply unit 5 into the stand-by mode after a first time since the setting of control group 17 from the active configuration into the rest configuration supersedes the determined time and/or after a second time since interruption, in use, of the supply of the energy to cooking zones 2 supersedes the determined time.

Furthermore, auxiliary control device 26 is configured to be set in the deactivated configuration with power supply unit 5 being controlled in the stand-by-mode. In particular, auxiliary control device 26 when being in the deactivated configuration t execute any control operating on power supply unit 5. The only means on controlling power supply unit 5 back to the powered-on mode is by control group 17 and the movement of magnetic and/or ferromagnetic element 19 from the rest positon to the active state by means of the interaction with the activation device.

In further detail, auxiliary control device 26 comprises an auxiliary electric circuit 27 and an auxiliary switching device 28 for selectively setting auxiliary electric circuit 27 into an opening state and a closing state.

In particular, in use, auxiliary electric circuit 27 is set in the opening state with power supply unit 5 being in the stand-by mode and being set in the closing state when power supply unit 5 is controlled from the stand-by mode in the powered-on mode.

More specifically, auxiliary switching device 28 may be configured to retain auxiliary electric circuit 27 in the closed state after control group 17 is controlled, in use, back from the active configuration to the rest configuration.

Even more specifically, auxiliary switching device 28 may comprise a relay 29 and a switching element 30 controlled by relay 30 such that switching element 30 can open and close auxiliary electric circuit 27, or in other words to set auxiliary electric circuit 27 between respectively the opening state and the closing state.

With reference to FIG. 2, number 1′ indicates an alternative embodiment of a domestic appliance according to the present invention; as domestic appliance 1′ is similar to domestic appliance 1, the following description is limited to the differences between them, and using the same references, where possible, for identical or corresponding parts.

In particular, domestic appliance 1′ differs from domestic appliance 1 in that magnetic switching device 18 comprises a reed switch 31 carrying and/or defining and/or comprising magnetic and/or ferromagnetic element 19.

More specifically, reed switch 31 comprises a moveable first contact arm 32 having and/or defining and/or comprising the magnetic and/or ferromagnetic element 19 and a (substantially fixed) second contact arm 33. In particular, first contact arm 32 is moveable for moving magnetic and/or ferromagnetic element 19 between the rest state at which first contact arm 32 is detached from second contact arm 33 and the active state at which first contact arm 32 and second contact arm 33 contact one another.

As operation of domestic appliance 1′ is similar to operation of domestic appliance 1, we refer to the description of the function of domestic appliance 1.

With reference to FIG. 3, number 1″ indicates an alternative embodiment of a domestic appliance according to the present invention; as domestic appliance 1″ is similar to domestic appliance 1 and domestic appliance 1′, the following description is limited to the differences between them, and the using same references, where possible, for identical or corresponding parts.

In particular, domestic appliance 1″ differs from domestic appliance 1 and domestic appliance 1′ in that main control unit 7 comprises auxiliary control device 26. Therefore, according to such an embodiment, main control unit 7 is also configured to control power supply unit 5 such to retain power supply unit 5 within the powered-on mode (once it has been controlled in the powered-on mode by control group 17).

As operation of domestic appliance 1″ is similar to operation of domestic appliance 1 and domestic appliance 1″, we refer to the above-provided description.

Clearly, changes may be made to domestic appliance 1 without, however, departing from the scope of the present invention.

### LIST OF REFERENCE SIGNS

1, 1′, 1″ Domestic appliance
2 cooking zone
3 Cooking hob
4 Cooking vessel
5 Power supply unit
6 External power supply
7 Main control unit
8 Support panel
9 First face
10 Second face
11 Support portion
15 Induction coil
16 Generator
17 Control group
18 Magnetic switching device
19 Magnetic element
20 Electric control circuit
21 Switching element
22 Contact portion
23 Auxiliary portion
26 Auxiliary control device
27 Auxiliary electric circuit
28 Auxiliary switching device
29 Relay
30 Switching element
31 Reed switch
32 First contact arm
33 Second contact arm

1. Domestic appliance for thermal treatment of food products comprising:
one or more cooking zones;
a power supply unit being controllable into at least a stand-by mode and a powered-on mode and being configured to supply energy to the one or more cooking zones when being controlled in the powered-on mode; and
a control group coupled to the power supply unit and configured to control the power supply unit from the stand-by-mode into the powered-on mode; wherein the control group is controllable between a rest configuration and an active configuration at in which the control group is configured to set the power supply unit from the stand-by-mode into the powered-on mode;
wherein the control group comprises a magnetic switching device having a magnetic and/or ferromagnetic element, the magnetic and/or ferromagnetic element being moveable between a rest state and an active state;
wherein the control group is controlled in the rest configuration and the active configuration with the magnetic and/or ferromagnetic element being positioned in the rest state and the active state, respectively;
wherein the magnetic and/or ferromagnetic element is biased in the rest state and is controllable into the active state by means of interaction with a metallic and/or magnetic and/or ferromagnetic activation device.

2. Domestic appliance according to claim 1, further comprising an auxiliary control device configured to enter an activated auxiliary configuration with the control group being set from the rest configuration to the active configuration;
wherein the auxiliary control device is configured to retain the power supply unit in the powered-on mode with the control group being set back from the active configuration in the rest configuration.

3. Domestic appliance according to claim 2, wherein the auxiliary control device is configured to retain the power supply unit in the powered-on mode for a determined time after control of the control group from the active configuration into the rest configuration and/or after interrupting, in use, a supply of the energy to the one or more cooking zones.

4. Domestic appliance according to claim 2, wherein the auxiliary control device is configured to control the power supply unit into the stand-by mode after a first time since the setting of the control group from the active configuration into the rest configuration supersedes a first determined time and/or after a second time since interruption, in use, of the supply of the energy to the one or more cooking zones supersedes a second determined time.

5. Domestic appliance according to claim 2, wherein the auxiliary control device is configured to be set in a deactivated auxiliary configuration with the power supply unit being controlled in the stand-by-mode.

6. Domestic appliance according to claim 2, wherein the auxiliary control device comprises an auxiliary electric circuit and an auxiliary switching device for selectively setting the auxiliary electric circuit into a respective opening state and a respective closing state;
wherein the auxiliary electric circuit is set in the opening state with the power supply unit being set in the stand-by mode.

7. Domestic appliance according to claim 6, wherein the auxiliary switching device is configured to retain the auxiliary electric circuit in the closing state after the control group is controlled, in use, back from the active configuration to the rest configuration.

8. Domestic appliance according to claim 1, wherein the control group comprises an electric control circuit having the magnetic switching device and configured to be set between an open state and a closed state;
wherein the electric control circuit is controlled in the open state and the closed state with the magnetic and/or ferromagnetic element being in respectively the rest state and the active state.

9. Domestic appliance according to claim 1, wherein the magnetic switching device comprises a reed switch carrying and/or defining and/or comprising the magnetic and/or ferromagnetic element.

10. Domestic appliance according to claim 1, wherein the magnetic switching device comprises a moveable elongated switching element carrying the magnetic and/or ferromagnetic element at a first end portion.

11. Domestic appliance according to claim 10, wherein the switching element is axially moveable around a rotation axis for moving the magnetic and/or ferromagnetic element between a first angular position and a second angular position at which the magnetic and/or ferromagnetic element is in the rest state and the active state, respectively.

12. Domestic appliance according to claim 1, further comprising a support panel comprising and/or at least partially carrying the one or more cooking zones;
wherein the support panel comprises a first face and a second face opposed to the first face;
wherein each cooking zone is configured to support at least one respective cooking vessel facing and/or contacting the first face of the support panel;
wherein the magnetic switching device is arranged adjacent to and faces the second face.

13. Domestic appliance according to claim 1, wherein the activation device is a distinct from a cooking vessel.

14. Domestic appliance according to claim 1, wherein each one of the one or more cooking zones comprises one or more respective induction coils, and one or more generators, each one coupled to at least one said respective induction coil for driving the respective induction coil.

15. Domestic appliance according to claim 1, comprising a plurality of magnetic switching devices, at least some of which are associated to respective cooking zones;
wherein each one of the magnetic switching devices is configured to set the control group into the active configuration.

16. A domestic appliance comprising:
a cooking hob having a support panel with a first face and a second face, the support panel configured to support one or more cooking vessels on the first face thereof within respective cooking zone(s) of the hob;
a power supply unit configured to supply cooking energy to the one or more cooking zones;
a control group couplable to an external power source and coupled to the power supply unit, said control group comprising a main control circuit having therein a magnetically actuated main control switch and configured to supply power from the external power source, when coupled thereto, to the power supply unit, the main control switch being located adjacent to the second face of the support panel and being biased open, the main control switch being magnetically actuable to close the main control switch via magnetic interaction with a ferromagnetic activation device when located adjacent to the first face of the support panel opposite the second face adjacent to where said main control switch is located; and
an auxiliary control device also couplable to the external power source and coupled to the power supply unit, said auxiliary control device comprising an auxiliary control circuit arranged in parallel to the main control circuit, said auxiliary control circuit having therein an auxiliary control switch actuable by a relay;
wherein the auxiliary control device is configured to:
close the auxiliary control switch upon closing of the main control switch via magnetic interaction thereof with the ferromagnetic activation device; and
retain the auxiliary control switch in its closed configuration during an auxiliary-control time period after opening of the main control switch, via removal of interaction thereof with the ferromagnetic activation device, until:
a predetermined length of time has elapsed; or
after interruption of a supply of cooking energy to the one or more cooking zones,
and thereupon to open the auxiliary control switch;
and wherein the auxiliary control switch cannot be closed from its open configuration independent of the main control switch being actuated to close the main control switch against its bias via magnetic interaction with the ferromagnetic activation element.

17. The domestic appliance according to claim 16, said main control switch being disposed within one of said one or more cooking zones, wherein the ferromagnetic activation device is a ferromagnetic cooking utensil such that the main control switch is closed upon placing the ferromagnetic cooking utensil on the second face of the support panel in said one cooking zone.

18. The domestic appliance according to claim 17, said cooking hob being an induction cooking hob, each cooking zone comprising, respectively, an induction coil and a generator coupled thereto, said power supply unit being configured to supply the cooking energy to each generator, the appliance further comprising a control unit coupled to and configured to operate each generator via cooking energy supplied by the power supply unit in order to cook food in the respective cooking zone, the control unit further coupled to and configured to control the auxiliary control device to regulate retention of the auxiliary control switch in its closed configuration during the auxiliary control time period.

19. The domestic appliance according to claim 18, comprising a plurality of said cooking zones, each said cooking zone having a respective control group whose main control switch is located adjacent to the second face of the support panel in the respective cooking zone.
